(19) United States
(12) Patent Application Publication
(10) Pub. No.: US 2025/0029418 A1
(43) Pub. Date: Jan. 23, 2025

(54) METHODS AND TECHNIQUES TO CLASSIFY STAGES IN THE GONOTROPHIC CYCLE OF MOSQUITOES FROM IMAGES USING COMPUTER VISION TECHNIQUES

(71) Applicant: University of South Florida, Tampa, FL (US)

(72) Inventors: Sriram Chellappan, Tampa, FL (US); Farhat Azam, Tampa, FL (US); Ryan M. Carney, Tampa, FL (US); Sherzod Kariev, San Bruno, CA (US)

(21) Appl. No.: 18/776,899

(22) Filed: Jul. 18, 2024

Related U.S. Application Data
(60) Provisional application No. 63/514,558, filed on Jul. 19, 2023.

(51) Int. Cl. G06V 40/10; G06V 10/26; G06V 10/764; G06V 10/774; G06V 10/776; G06V 10/82; G06V 20/52

(52) U.S. Cl. CPC G06V 40/10; G06V 10/26; G06V 10/764; G06V 10/774; G06V 10/776; G06V 10/82; G06V 20/52

(57) ABSTRACT

Embodiments of the present disclosure automate the identification of gonotrophic stages in mosquitoes. An example computer-implemented method can include: receiving an image data set; processing at least a portion of the image data set using an image segmentation operation to determine a current gonotrophic phase for each of at least a portion of the plurality of mosquitoes; determining, using a trained machine learning model and based at least in part on the determined current gonotrophic phases, a predictive output indicative of an expected population of mosquitoes at the location during a future time period; and outputting an indication of the expected population of mosquitoes.

### CROSS-REFERENCE TO RELATED APPLICATIONS

This application claims the benefit of and priority to U.S. Provisional Patent App. No. 63/514,558, filed Jul. 19, 2023, the content of which is incorporated herein by reference in its entirety.

### BACKGROUND

Mosquitoes spread many diseases including malaria, dengue, chikungunya, yellow fever, and Zika [1]. In Africa alone, malaria is responsible for the deaths of more than 750,000 people annually, most of them being children [2]. For efforts to model and combat the spread of mosquitoes and mosquito-borne diseases, identifying the gonotrophic stage of the female mosquito is critical for assessing behavior, age, and suitability for different analyses [3,4]. This gonotrophic cycle governs the reproduction of mosquitoes, and consists of four stages. The first is when a female adult is yet to consume a blood meal, the unfed stage. When a female mates, it needs to take a blood meal for the eggs to mature. When the mosquito has acquired a full blood meal, its eggs are ready to mature, and the mosquito is in the fully fed stage. The next stage is when the eggs have started to mature as the blood is being digested, and this is called the semi-gravid or half-gravid stage. When the eggs are fully mature (i.e., when the blood is fully digested), the mosquito is in the gravid stage. In general, extensive, entomological training and time-consuming manual effort are necessary for monitoring mosquitoes for the surveillance and control of mosquito-borne diseases. Existing techniques are incapable of identifying abdominal conditions of adult female mosquitoes, which may be useful for monitoring and tracking mosquito populations to facilitate coordination and development of control measures based on changing environmental conditions.

There is a need for systems and methods for identifying and monitoring mosquitoes that are capable of distinguishing various abdominal conditions of adult female mosquitoes.

### SUMMARY

Embodiments of the present disclosure automate the identification of gonotrophic stages in a female mosquito. Today, this process is manual, time-consuming, and requires trained expertise that is increasingly harder to find. Each mosquito specimen has to be visually analyzed to look for the color and shape of the abdomen to make a determination of the gonotrophic stage, and there is a need to automate this process. With automation, mosquito observations from the general public can also be processed, which can provide larger-scale surveillance data for public health agencies.

In some implementations, a computer-implemented method is provided. The computer-implemented method can include: receiving, by at least one processor, an image data set, wherein the image data set includes a plurality of images that each depict a respective mosquito of a plurality of mosquitoes at a location; processing, by the at least one processor, at least a portion of the image data set using an image segmentation operation to determine a current gonotrophic phase for each of at least a portion of the plurality of mosquitoes; determining, by the at least one processor using a trained machine learning model and based at least in part on the determined current gonotrophic phases, a predictive output indicative of an expected population of mosquitoes at the location during a future time period; and outputting, by the at least one processor, an indication of the expected population of mosquitoes.

In some implementations, the computer-implemented method further includes: triggering, by the at least one processor, an alert and/or corrective operation in an instance in which the expected population meets or exceeds a predetermined threshold value.

In some implementations, the corrective operation includes generating and/or outputting an indication of a mosquito population control plan.

In some implementations, each current gonotrophic phase is unfed, fully fed, semi-gravid, or gravid state.

In some implementations, processing at least a portion of the image data set includes identifying female mosquitoes in at least a portion of the image data set.

In some implementations, the expected population of mosquitoes is determined based at least in part on a ratio of gravid to fully fed mosquitoes at the location.

In some implementations, the image data set is captured via at least one image sensor of at least one mobile device.

In some implementations, the computer-implemented method further includes: performing, by the at least one processor, a dimensionality reduction operation on at least a portion of the image data set.

In some implementations, processing at least a portion of the image data set includes performing a depth-wise convolution operation.

In some implementations, the machine learning model includes at least one of a deep learning model, a neural network model, a transformer-based model, or a convolutional neural network model (e.g., EfficientNet-b0).

In some implementations, a system is provided. The system can include: at least one processor (e.g., cloud-based processing system); and a memory having instructions thereon, wherein the instructions when executed by the at least one processor, cause the at least one processor to: receive an image data set, wherein the image data set includes a plurality of images that each depict a respective mosquito of a plurality of mosquitoes at a location; process at least a portion of the image data set using an image segmentation operation to determine a current gonotrophic phase for each of at least a portion of the plurality of mosquitoes; determine, using a trained machine learning model and based at least in part on the determined current gonotrophic phases, a predictive output indicative of an expected population of mosquitoes at the location during a future time period; and output an indication of the expected population of mosquitoes.

In some implementations, a method is provided. The method can include: feeding a subset of a plurality of mosquitoes at a location to reach a gravid state; generating a first training image data set from a plurality of images, wherein each image depicts at least one of the plurality of mosquitoes; augmenting the first training image set using at least one image augmentation operation to generate a second training image data set; training a machine learning model using the second training image data set; and validating performance of the trained machine learning model using the first training image data set.

In some implementations, each image is obtained via a different image sensor and/or mobile device and/or from multiple angles.

In some implementations, the at least one image augmentation operation includes at least one of: rotating clockwise and counter-clockwise, flipping horizontally and vertically, changing blurriness and sharpness, altering brightness randomly from 5% to 20%, or manually cropping images to extract only a mosquito body.

In some implementations, training the machine learning model includes a first training stage performed at a higher learning rate and a second training stage performed at a smaller learning rate.

In some implementations, pixels corresponding with a mosquito abdomen in each image are weighted higher than pixels corresponding to other body parts.

In some implementations, the method further includes: determining an efficiency of the trained machine learning model; and outputting a visualization corresponding to the determined efficiency.

In some implementations, the visualization includes a localization map showing pixels in each image that were prioritized for classification of each mosquito.

In some implementations, the method further includes: analyzing gradients of at least one target class as it propagates through the machine learning model; and generating a localization map based on the analyzed gradients.

In some implementations, the machine learning model includes at least one of a deep learning model, a neural network model, a transformer-based model, or a convolutional neural network model (e.g., EfficientNet-b0).

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 is a block diagram of an example system that can be used for the identification of gonotrophic stages in mosquitoes, according to certain implementations.

FIG. 2A is a flow chart diagram of an example computer-implemented method, according to certain implementations.

FIG. 2B is a flow chart diagram of an example method for training a machine learning model, according to certain implementations.

FIG. 3 shows abdominal conditions of a female mosquito according to stages of its gonotrophic cycle.

FIGS. 4A-4D show experimental results for four trained AI models from a conducted study.

FIGS. 5A-5C, FIGS. 6A-6C, FIGS. 7A-7C, and FIGS. 8A-8C show specific instances of Grad-CAM outputs on test images based on classifications made by the proposed EfficientNet-B0 model.

FIG. 9 shows eight augmented images with the original image of a sample mosquito.

FIG. 10A and FIG. 10B are graphs showing the loss and accuracy for each iteration during training and validation of the proposed EfficientNet-B0 model.

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

### DETAILED DESCRIPTION

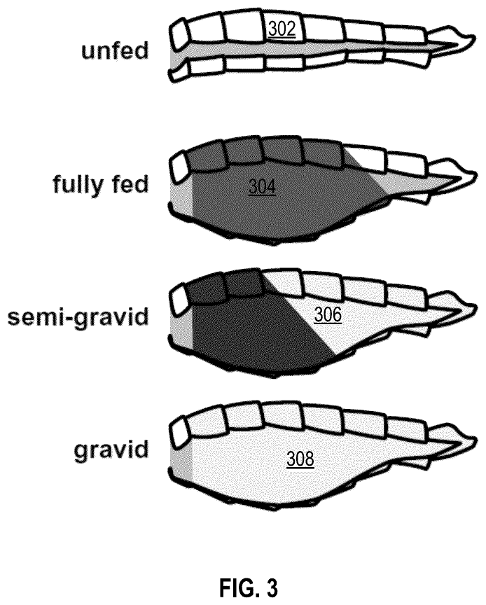

The ability to distinguish between the abdominal conditions of adult female mosquitoes has important utility for the surveillance and control of mosquito-borne diseases. However, doing so requires entomological training and time-consuming manual effort. Here, we propose and design computer vision techniques to determine stages in the gonotrophic cycle of female mosquitoes from images. Our dataset was collected from 139 adult female mosquitoes across three medically important species—Aedes aegypti, Anopheles stephensi, and Culex quinquefasciatus—and all four gonotrophic stages of the cycle (unfed, fully fed, semi-gravid, and gravid). FIG. 3 shows abdominal conditions of a female mosquito according to stages of its gonotrophic cycle. In particular, FIG. 3 shows an unfed mosquito 302, a fully fed mosquito 304, a semi-gravid mosquito 306, and a gravid mosquito 308.

From these mosquitoes and stages, a total of 1959 images were captured on a plain background via multiple smartphones. Subsequently, we trained four distinct AI model architectures (ResNet50 [5], MobileNetV2 [6], EfficientNet-B0 [7], and ConvNextTiny [8]), validated them using unseen data, and compared their overall classification accuracies. Additionally, we analyzed t-SNE plots to visualize the formation of decision boundaries in a lower-dimensional space. Notably, ResNet50 and EfficientNet-B0 demonstrated outstanding performance with an overall accuracy of 97.44% and 93.59%, respectively. EfficientNet-B0 demonstrated the best overall performance considering computational efficiency, model size, training speed, and t-SNE decision boundaries. We also assessed the explainability of this EfficientNet-B0 model, by implementing Grad-CAMs—a technique that highlights pixels in an image that were prioritized for classification. We observed that the highest weight was for those pixels representing the mosquito abdomen, demonstrating that our AI model has indeed learned correctly. Our work has significant practical impact. First, image datasets for gonotrophic stages of mosquitoes are not yet available. Second, our algorithms can be integrated with existing citizen science platforms that enable the public to record and upload biological observations. With such integration, our algorithms will enable the public to contribute to mosquito surveillance and gonotrophic stage identification and can augment these efforts by enabling the automated detection of gonotrophic stages of mosquitoes in addition to mosquito species identification.

### Example System

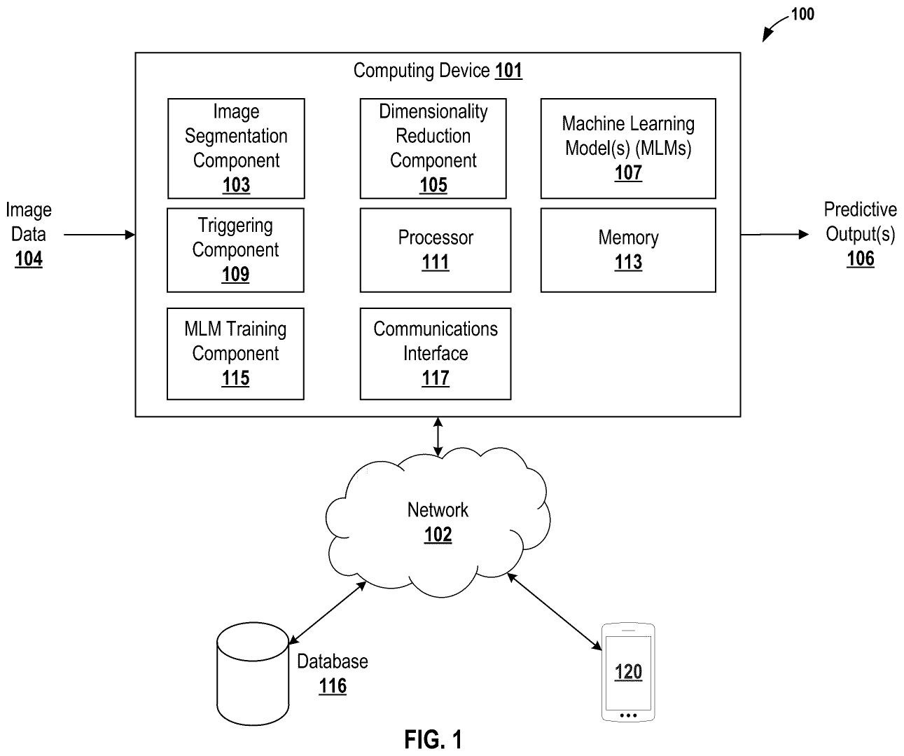

Referring now to FIG. 1, a block diagram of an example system 100 that can be used for the identification of gonotrophic stages in mosquitoes is shown, according to certain implementations. The system 100 includes a computing device 101 configured to receive raw image data 104, process the raw image data 104 to form an image data set, and generate predictive output(s) 106 associated therewith. As depicted in FIG. 1, the computing device 101 is in electronic communication with a database 116 and one or more other computing devices 120 (e.g., mobile devices, smartphones, computers, and the like). The system 100 can include any number of databases 116 and other computing devices 120. In some implementations, the system 100 can be or include a cloud-based processing system.

In the example shown in FIG. 1, the computing device is shown to include an image segmentation component 103, a dimensionality reduction component 105, one or more machine learning models 107, a triggering component 109, at least one processor 111, at least one memory 113, and a machine learning model training component 115. The at least one processor 111 can be a general-purpose processor, an ASIC, one or more FPGAs, groups of processing components, or other suitable electronic processing structures. In some embodiments, the at least one processor 111 is configured to execute program code stored on the memory 113 to cause the processor to perform one or more operations, as described below in greater detail below.

Memory 113 can include one or more devices (e.g., memory units, memory devices, storage devices, etc.) for storing data and/or computer code for completing and/or facilitating the various processes described in the present disclosure. In some embodiments, memory 113 includes tangible (e.g., non-transitory), computer-readable media that stores code or instructions executable by processors 111. Tangible, computer-readable media refers to any physical media that is capable of generating and/or providing data. Example tangible, computer-readable media may include, but is not limited to, volatile media, non-volatile media, removable media and non-removable media implemented in any method or technology for storage of information such as computer readable instructions, data structures, program modules or other data. Accordingly, memory 113 can include RAM, ROM, hard drive storage, temporary storage, non-volatile memory, flash memory, optical memory, or any other suitable memory for storing software objects and/or computer instructions. Memory 113 can include database components, object code components, script components, or any other type of information structure for supporting the various activities and information structures described in the present disclosure. Memory 113 can be communicably connected to processors 111, such as via processing circuit, and can include computer code for executing one or more processes described herein.

While shown as individual components, it will be appreciated that the processor and/or memory 113 can be implemented using a variety of different types and quantities of processors and memory. In some embodiments, the computing device 101 may be distributed across multiple servers or computers (e.g., that can exist in distributed locations). For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by two or more computers.

Additionally, the computing device 101 is shown to include a communications interface 117, that facilitates communication of data, control signals, and/or other information. For example, communications interface 117 can provide means for transmitting data to, or receiving data from, database 116 or computing device 120. Accordingly, communications interface 117 can be or can include a wired or wireless communications interface (e.g., jacks, antennas, transmitters, receivers, transceivers, wire terminals, and the like) for conducting data communications, or a combination of wired and wireless communication interfaces. In some embodiments, communications via communications interface 117 are direct (e.g., local wired or wireless communications) or via a network 102 (e.g., a WAN, the Internet, a cellular network, and the like). For example, communications interface 117 may include one or more Ethernet ports for communicably coupling to the network 102 (e.g., the Internet). In another example, communications interface 117 can include a Wi-Fi transceiver for communicating via a wireless communications network. In yet another example, communications interface 117 may include cellular or mobile phone communications transceivers.

### Example Methods

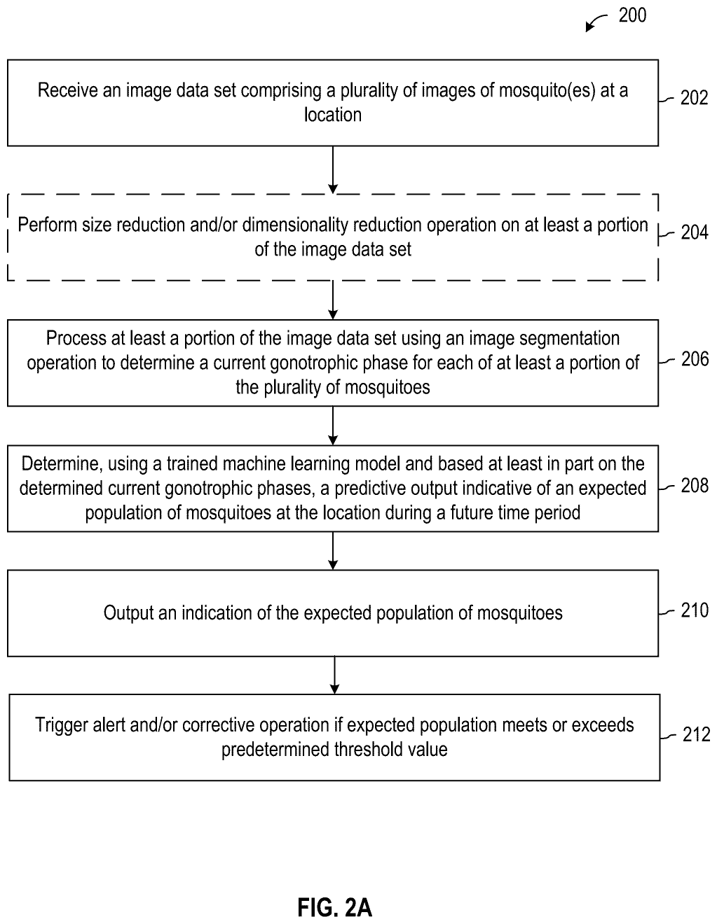

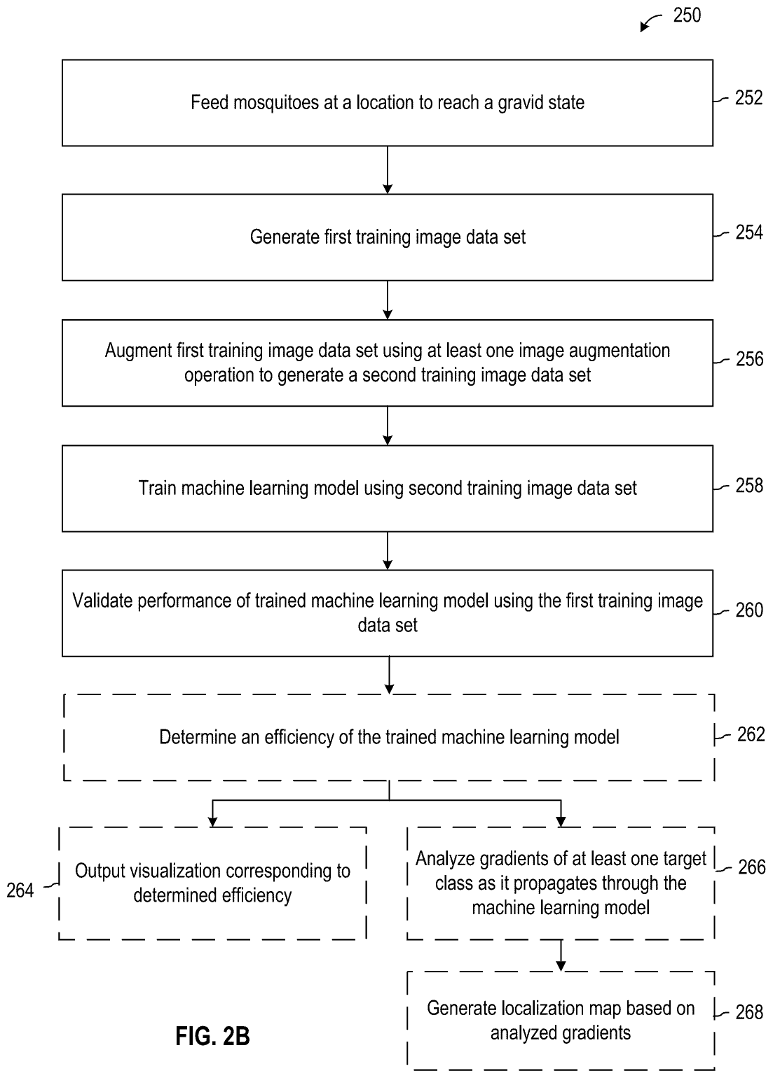

Referring now to FIG. 2A, a flow chart diagram of an example computer-implemented method 200 for generating a predictive output indicative of an expected population of mosquitoes at a particular location during a future time period is provided. In some implementations, one or more steps/operations of the method 200 may be performed by the computing device 101 (e.g., processor 111) described above in connection with FIG. 1. It will be appreciated that certain steps of method 200 may be optional and, in some implementations, the method 200 may be implemented using less than all of the steps. It will also be appreciated that the order of steps shown in FIG. 2A is not intended to be limiting.

At step/operation 202, the method 200 includes receiving (e.g., obtaining, retrieving) an image data set. The image data set can comprise a plurality of images that each depict a respective mosquito of a plurality of mosquitoes at a location. In some implementations, the plurality of images are obtained via respective image sensors of a plurality of mobile devices (e.g., computing device(s) 120 described in connection with FIG. 1). In other words, multiple end users can upload mosquito images from different locations and the computing device (e.g., 101) can group images to form different image data sets for each location. In this manner, the system 100 can generate and continuously update predictive outputs for each of a plurality of locations based on newly received data.

Optionally, at step/operation 204, the method 200 includes performing a size reduction and/or dimensionality reduction operation on at least a portion of the image data set. For example, each image can be modified to a predetermined size or quality for consistency. By using dimensionality reduction operations to reduce the number of input variables in a given image data set, the computing device can decrease overall computational costs and mitigate various technical challenges associated with data processing in high-dimensional domains including overfitting, poor visualization, computational complexity, and data sparsity. Accordingly, the dimensionality reduction operations can improve overall model performance. This disclosure contemplates that other pre-processing operations can be performed on received raw image data to improve model performance and accuracy including normalization to improve convergence during training and/or ensure consistent intensity values, denoising and/or smoothing to reduce noise in the images and enhance quality, image conversion (e.g., converting images from greyscale to binary images) to simplify subsequent operations, and/or cropping to focus on areas of interest (e.g., female mosquitos) in the image data set.

At step/operation 206, the method 200 includes processing at least a portion of the image data set using an image segmentation operation to determine a current gonotrophic phase for at least a portion of the mosquitos in a given image data set. The image segmentation operation can comprise semantic segmentation, instance segmentation, model-based segmentation, watershed segmentation, clustering-based segmentation, edge or region-based segmentation and/or thresholding segmentation techniques. The gonotrophic phase for each mosquito can be one of various predetermined states such as unfed 302, fully fed 304, semi-gravid 306, and gravid state 308 as described in relation to FIG. 3. Features that may be relevant in determining (e.g., classifying, identifying) that a mosquito is in a particular gonotrophic phase can include, for example, without limitation, color-related features and abdomen size and/or shape. In some implementations, step/operation 206 includes identifying (e.g., extracting) female mosquitoes from the image data set (e.g., determining a ratio of female to male mosquitoes).

At step/operation 208, the method 200 includes determining, using a trained machine learning model and based at least in part on the determined current gonotrophic phases, a predictive output indicative of an expected population of mosquitoes at the location during a future time period (e.g., day(s), month(s), certain weeks or hours, and/or the like). The machine learning model can be or comprise at least one of a deep learning model, a neural network model, a transformer-based model, or a convolutional neural network model (e.g., EfficientNet-b0, discussed in more detail below). In some examples, the expected population of mosquitoes is determined based at least in part on a ratio of gravid to fully fed mosquitoes at the location. In some implementations, the method 200 includes performing a depth-wise convolution operation on at least a portion of the image data set. In contrast with standard convolution techniques, depth-wise convolution applies each of a plurality of filters to a single input channel resulting in the same number of input channels and output channels, where each output channel is generated by convolving a respective input channel with a unique filter. This reduces the number of model parameters and computational costs associated therewith and can enhance efficiency of the model in resource-limited applications.

At step/operation 210, the method 200 includes outputting an indication of the expected population of mosquitoes, for example, to a graphical user interface of the computing device(s) 101, 120. These indications can be used to trigger further operations. In some implementations, the computing device 101 can transmit such information to a server where it may be stored in a database 116 for subsequent analysis, to update one or applications (e.g., a mobile device App), and/or used to generate and send indications to computing devices 120 in communication therewith or in response to requests for such information.

At step/operation 212, the method 200 includes triggering an alert and/or corrective operation in an instance in which the expected population meets or exceeds a predetermined threshold value. In some implementations, the corrective operation is a mosquito population control plan and/or user interface data associated therewith. By way of example, if the predicted mosquito population for a given location is above a predetermined threshold value, the computing device (e.g., 101) can generate an alert for new or additional pesticide control measures to be taken at the location, including, for example, a timing (e.g., date, time of day) and area(s) where particular pesticides should be applied to optimize mosquito control at the location. In some implementations, the alert can be distributed to a plurality of end users via a mobile device application, to advise the users to avoid the location during the future time period.

### Example Training Method

Referring now to FIG. 2B, a flow chart diagram of an example method 250 for training a machine learning model that can be used to generate predictive outputs as described herein is shown.

At step/operation 252, the method 250 includes feeding a subset of a plurality of mosquitoes at a location to reach a gravid state.

At step/operation 254, the method 250 includes generating a first training image data set from a plurality of images, wherein each image depicts at least one of the plurality of mosquitoes. In some implementations, each image is obtained via a different image sensor and/or mobile device and/or from multiple angles.

At step/operation 256, the method 250 includes augmenting the first training image set using at least one image augmentation operation to generate a second training image data set. In some implementations, the at least one image augmentation operation comprises at least one of: rotating clockwise and counter-clockwise, flipping horizontally and vertically, changing blurriness and sharpness, altering brightness randomly from 5% to 20%, or manually cropping images to extract only a mosquito body. In some implementations, step/operation 256 can include any of the pre-processing steps described above in relation to FIG. 2A.

At step/operation 258, the method 250 includes training a machine learning model using the second training image data set. In some embodiments, pixels corresponding with a mosquito abdomen in each image are weighted higher than pixels corresponding to other body parts. In some implementations, training the machine learning model comprises a first training stage performed at a higher learning rate and a second training stage performed at a smaller learning rate (also referred to as ‘lower learning rate’). Training at a higher learning rate speeds up the training process in the first training stage while training at a lower learning rate in the second training stage facilitates fine-tuning of model parameters. Accordingly, the proposed training method provides an optimal balance between training speed and model accuracy (i.e., training only at a higher learning rate may reduce overall model accuracy, while training only at a smaller learning rate may increase the length of time required for model training and associated computational costs).

At step/operation 260, the method 250 includes validating performance of the trained machine learning model using the first training image data set.

Optionally, at step/operation 262, the method 250 includes determining an efficiency of the trained machine learning model.

At step/operation 264, the method 250 includes outputting a visualization corresponding to the determined efficiency. In some implementations, the visualization comprises a localization map showing pixels in each image that were prioritized for classification of each mosquito.

Additionally, and/or alternatively, at step/operation 266, the method 250 includes analyzing gradients of at least one target class as it propagates through the machine learning model.

At step/operation 268, the method 250 includes generating a localization map based on the analyzed gradients.

The above-noted operations of FIG. 2B (e.g., Step/operation 262-268) facilitate analysis of performance, resource utilization, latency, throughput, energy consumption, model interpretability, deployment, and maintenance with respect to the trained machine learning model (e.g., by a developer). Accordingly, the method 250 ensures that target metrics are satisfied prior to, during, and/or after model deployment.

Further, the above-noted operations of FIG. 2B (e.g., Step/operation 266-268) facilitate identifying which input features are most influential on a model's predictions for a given class and can provide insight on the model's functionality. Additionally, these operations facilitate error analysis, debugging, future model upgrades, bias detection, feature selection, and/or the like.

### Machine Learning

In addition to the machine learning operations described above, the exemplary system can be implemented using one or more artificial intelligence and machine learning operations. The term “artificial intelligence” can include any technique that enables one or more computing devices or comping systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include but are not limited to artificial neural networks or multilayer perceptron (MLP).

Machine learning models include supervised, semi-supervised, and unsupervised learning models. In a supervised learning model, the model learns a function that maps an input (also known as feature or features) to an output (also known as target) during training with a labeled data set (or dataset). In an unsupervised learning model, the algorithm discovers patterns among data. In a semi-supervised model, the model learns a function that maps an input (also known as feature or features) to an output (also known as a target) during training with both labeled and unlabeled data.

Neural Networks. An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include but are not limited to backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by down-sampling). A fully-connected layer includes neurons, where each neuron is connected to all of the neurons in the previous layer. The layers are stacked similar to traditional neural networks. GCNNs are CNNs that have been adapted to work on structured datasets such as graphs.

A transformer-based model (e.g., a vision transformer model) is a type of neural network architecture that relies on a self-attention mechanism to determine representations of input sequences, facilitating the determination of contextual relationships and dependencies effectively. To process image data, a transformer-based model can partition an image into fixed-sized patches (e.g., groups of pixels), convert each patch into a vector, and embed each vector into a high-dimensional space. Patch embeddings with corresponding positional encodings which are used to retain spatial information can be fed into a transformer encoder where the self-attention mechanism allows the model to identify relationships between the various patches.

### Experimental Results and Examples

A study was conducted to evaluate the proposed system and method. A total of 97 female mosquitoes in a lab and were let to go through all four stages in the gonotrophic cycle. The mosquitoes were distributed between three medically important vector species—Aedes (Ae.) aegypti, Culex (Cx.) quinquefasciatus, and Anopheles (An.) stephensi. Subsequently, as the mosquitoes went through each stage, our team took pictures of them via multiple smartphones on a plain grey or white background to generate a total of 1379 images (details on our dataset are provided below). In addition, 42 Anopheles stephensi mosquitoes were raised at a lab in the US, from which we took 580 images of these mosquitoes in their unfed and semi-gravid stages via multiple smartphones on a similar background. Our total image dataset was thus 1959 images (see Table 1). Using this dataset, our contributions are the following.

Designing multiple neural network architectures for classification: In this study, we trained, fine-tuned, and tested four different neural network architectures for classifying gonotrophic stages—ResNet505 [5], Mobile-NetV26 [6], EfficientNet-B07 [7], and ConvNeXtTiny [8]. Each architecture provides contextual relevance to our classification problem, while also being diverse from the other in their design. The ResNet50 is popular, but computationally very expensive. The MobileNetV2 architecture is lighter and particularly suited for execution on embedded devices like smartphones. The EfficientNet-B0 architecture is newer and is a nice trade-off between good accuracy and lighter in complexity. Finally, the ConvNeXtTiny architecture is a hybrid of CNNs and the more recent Vision Transformers [9]. Our metrics to assess performance were precision, recall, F1-score, and accuracy. Our analysis identified that overall the EfficientNet-B0 architecture out-performed others. This model was able to yield an overall accuracy of 93.59%, with a tolerable model size and speed of execution. Most confusion happened between the gravid and semi-gravid stages across all models.

Visualizing the predictive ability of features using t-SNE Analysis: We leveraged the t-distributed Stochastic Neighbor Embedding (t-SNE) algorithm to construct a 2D plot to visualize the features extracted by our AI models. We observed that the results obtained from the EfficientNet-B0 model displayed distinct and separable features for each class, aligning precisely with the different stages of the gonotrophic cycle. This observation further substantiates the effectiveness of the EfficientNet-B0 model in gonotrophy stage classification.

Providing model explainability via Grad-CAMs: To further the explainability of our trained EfficientNet-B0 model, we utilized the Gradient-weighted Class Activation Mapping (Grad-CAM)11 technique to identify those pixels that the AI model prioritized in making a classification. Our findings demonstrate that our model gives the greatest weight to those pixels that represent the abdomen of the mosquito. This finding is important and indicates that our AI model has learned correctly because the visual markers for identifying stages in the gonotrophic cycle are indeed located in the abdomen of a mosquito (please refer to FIG. 3).

Highlighting the practical impact of our work: To the best of our knowledge, our study is the first to design and validate computer vision methods for automatic identification of the stages in the mosquito gonotrophic cycle. The practical impact of our study is elaborated later in this paper.

TABLE 1
Number of mosquito images and specimens
across three species in our dataset

| | Ae. aegypti | An. stephensi | Cx. quinquefasciatus |
|---|---|---|---|
| | Images | Images | Images |
| | (specimens) | (specimens) | (specimens) |
| Unfed | 151 (10) | 370 (23) | 58 (6) |
| Fully fed | 146 (20) | 176 (10) | 199 (7) |
| Semi-gravid | 121 (12) | 210 (19) | 107 (5) |
| Gravid | 118 (12) | 164 (9) | 139 (6) |

### Results: Classification Accuracies

The results here are for 234 images in our testing dataset that are unseen by the four AI models that we trained. They are presented in Table 2. Our metrics to test are Precision, Recall, F1-score, and Accuracy. These metrics are calculated the same way for each class and are defined below:

$$Precision = \frac{True Positive}{True Positive + False Positive} , \qquad ( 1 )$$

$$Recall = \frac{True Positive}{True Positive + False Positive} , \qquad ( 2 )$$

$$F 1 - score = 2 * \frac{Precision * Recall}{Precision + Recall} , \qquad ( 3 )$$

TABLE 2
Results for four classification model architectures on test images.

| | | | | | |
|---|---|---|---|---|---|
| Performance metrics | Unfed | Fully fed | Semi-gravid | Gravid | Avg. performance metrics |

ResNet50

| | | | | | |
|---|---|---|---|---|---|
| Precision | 100 | 96.08 | 100 | 91.84 | 96.98 |
| Recall | 100 | 94.23 | 95.45 | 100 | 97.42 |
| F1-score | 100 | 95.15 | 97.67 | 95.74 | 97.14 |
| Accuracy | 100 | 94.23 | 95.45 | 100 | 97.44 |

MobileNetV2

| | | | | | |
|---|---|---|---|---|---|
| Precision | 95.95 | 91.84 | 95.08 | 80.00 | 90.71 |
| Recall | 100 | 86.54 | 87.88 | 88.89 | 90.83 |
| F1-score | 97.93 | 89.11 | 91.34 | 84.21 | 90.65 |
| Accuracy | 100 | 86.53 | 87.88 | 88.89 | 91.45 |

EfficientNet-B0

| | | | | | |
|---|---|---|---|---|---|
| Precision | 97.26 | 96.00 | 95.24 | 83.33 | 92.96 |
| Recall | 100 | 92.31 | 90.91 | 88.89 | 93.03 |
| F1-score | 98.61 | 94.12 | 93.02 | 90.91 | 92.94 |
| Accuracy | 100 | 92.31 | 90.91 | 88.89 | 93.59 |

ConvNeXtTiny

| | | | | | |
|---|---|---|---|---|---|
| Precision | 94.20 | 92.31 | 89.66 | 69.09 | 86.31 |
| Recall | 91.55 | 92.31 | 78.79 | 84.44 | 86.77 |
| F1-score | 92.86 | 92.31 | 83.87 | 76.00 | 86.26 |
| Accuracy | 91.55 | 92.31 | 78.78 | 84.44 | 86.75 |

As shown in Table 2, the highest classification accuracy is yielded by the ResNet50 model, followed by the EfficientNet-B0 model. The lowest classification accuracy was yielded by the ConvNeXtTiny model, which is a new architecture combining the features of CNNs, and drawing inspiration from Vision Transformers [9]. Table 3 presents the confusion matrices for all four architectures. As we can see all models exhibit confusion classifying between semi-gravid and gravid mosquitoes. This is reasonable because the morphological differences between these two classes are very fine—extremely delicate and inexact changes in color across the abdomen of the mosquito—which sometimes confuses even trained entomologists.

To analyze the architectures further, Table 4 presents the complexity of the models trained, since it is also important that models are lightweight and leave minimal footprints in their execution. As we can see the ResNet50 model is the heaviest with a very large model size and features extracted. The EfficientNet-B0 model is much lighter in comparison. It is our judgment that for the problem of classifying gonotrophic stages, the EfficientNet-B0 model is most practical, since it is very accurate, and lightweight also, lending its ability to be executed in embedded devices like smartphones and edge computers, which is the practical need in mosquito surveillance.

The average inference time per image for the ResNet50, EfficientNet-B0, MobileNetV2, and ConvNeXtTiny models were 0.82, 1.22, 0.67, and 2.58 seconds respectively. These are small and tolerable delays.

TABLE 3
Confusion matrices for four classification
model architectures on test images.
(a) ResNet50

| | | Predicted | | | |
|---|---|---|---|---|---|
| | | Unfed | Fully fed | Semi-gravid | gravid |
| Actual | Unfed | 71 | 0 | 0 | 0 |
| | Fully fed | 0 | 49 | 0 | 3 |
| | Semi-gravid | 0 | 2 | 63 | 1 |
| | Gravid | 0 | 0 | 0 | 45 |

(b) MobileNetV2

| | | Predicted | | | |
|---|---|---|---|---|---|
| | | Unfed | Fully fed | Semi-gravid | Gravid |
| Actual | Unfed | 71 | 0 | 0 | 0 |
| | Fully fed | 0 | 45 | 1 | 6 |
| | Semi-gravid | 1 | 3 | 58 | 4 |
| | Gravid | 2 | 1 | 2 | 40 |

(c) EfficientNet-B0

| | | Predicted | | | |
|---|---|---|---|---|---|
| | | Unfed | Fully fed | Semi-gravid | Gravid |
| Actual | Unfed | 71 | 0 | 0 | 0 |
| | Fully fed | 0 | 48 | 0 | 4 |
| | Semi-gravid | 0 | 2 | 60 | 4 |
| | Gravid | 2 | 0 | 3 | 40 |

(d) ConvNeXtTiny

| | | Predicted | | | |
|---|---|---|---|---|---|
| | | Unfed | Fully fed | Semi-gravid | Gravid |
| Actual | Unfed | 65 | 1 | 0 | 5 |
| | Fully fed | 0 | 48 | 2 | 2 |
| | Semi-gravid | 3 | 1 | 52 | 10 |
| | Gravid | 1 | 2 | 4 | 38 |

Correctly predicted instances are in bold.

TABLE 4
Comparison of model architectures from a complexity perspective.

| | Number of | Number of | | | Num. of features extracted from |
|---|---|---|---|---|---|
| Model name | layers | parameters | Model size | | the last convolution layer |
| ResNet50 | 188 | 24,165,764 | 290.50 | MB | 2048 |
| MobileNetV2 | 167 | 1,763,508 | 21.80 | MB | 1280 |
| EfficientNet-B0 | 250 | 4,431,015 | 51.60 | MB | 1280 |
| ConvNeXtTiny | 164 | 28,070,500 | 337.80 | MB | 768 |

Features Visualization Using t-Distributed Stochastic Neighbor Embedding (1-SNE) Algorithm

In order to highlight the discriminatory power across the four classes of gonotrophic stages, we leverage the technique of t-SNE [10]. Basically, t-SNE is an unsupervised, non-linear technique for dimensionality reduction, and is used for visualizing high-dimensional data (in our case, the activation maps or output features of the final convolutional layer of our AI model). Basically, this method provides an intuition of how high-dimensional data points are related in low-dimensional space. As such, we can use this technique to evaluate the discriminatory power of the AI models.

To implement the t-SNE method, the following steps were executed for all four AI models. For each model, we start with the base, from which two sequential phases were executed. First, t-SNE builds up a probability distribution matrix for data points, which are the activation maps of the final convolutional layer of our AI model. For each pair, if there is a high level of similarity, a large probability value is assigned; otherwise, the probability value is small. Next, t-SNE considers those data points in a lower-dimensional space and generates another probability distribution. Here, the algorithm minimizes the loss or difference between the two probability distributions with respect to the locations on the map. To accomplish that, the algorithm calculates the Kullback-Leibler divergence (KL divergence) value and minimizes it over several iterations. This helps us understand how our AI model separates different classes in the data by visualizing how the decision boundaries are formed in a lower-dimensional space.

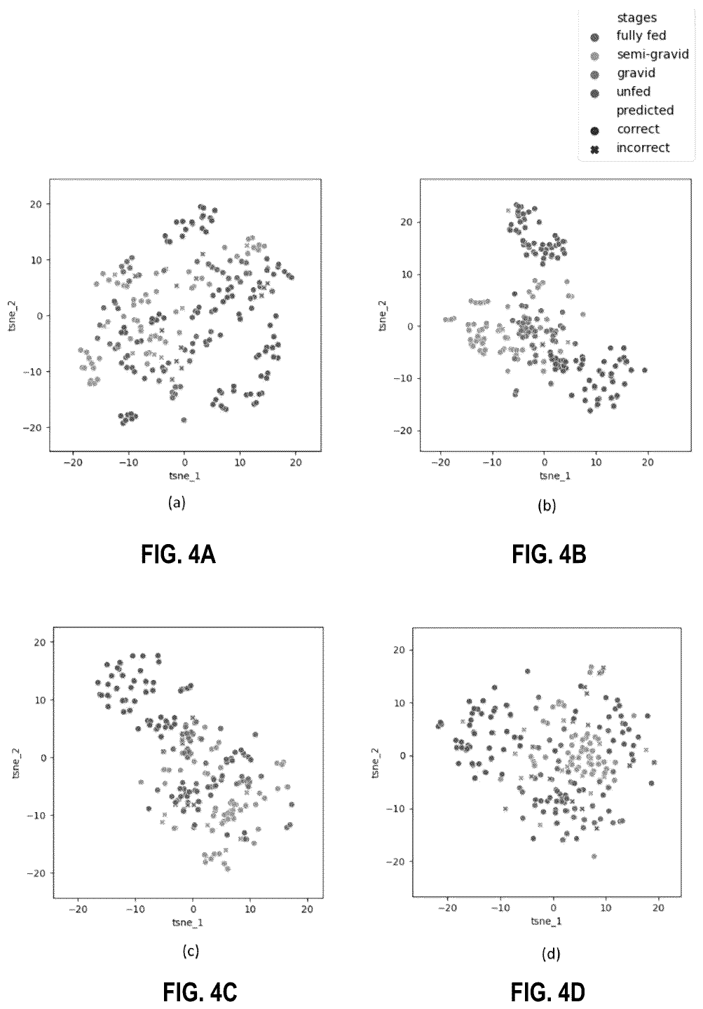

For each AI model, we obtained the activation maps from the final convolutional layer for all 234 test images, and each image resulted in a matrix with dimensions of 7×7×m (where m denotes the number of features extracted from the last convolution layer of each model (see Table 4)). To prepare the data for analysis, we flattened each image's feature matrix into an array of size 49×m. Subsequently, we applied the t-SNE algorithm to the flattened feature data of the 234 images, as described earlier. This process generated 2D coordinates for each image, allowing us to visualize them in a reduced space. In FIGS. 4A-4D, we show the resulting t-SNE plots for all four trained AI models. Specifically, FIG. 4A shows a feature map for ResNet50, FIG. 4B shows a feature maps for MobileNetV2, FIG. 4C shows a feature map for EfficientNet-B0, and FIG. 4D shows a feature map for ConvNextTiny. To provide additional information, we color-coded the images based on their gonotrophic stages as shown and used circles and crosses to denote correct and incorrect classifications.

While ResNet50 (FIG. 4A) and ConvNextTiny (FIG. 4D) achieved higher classification accuracies, they did not exhibit a clearly distinguishable t-SNE plot. On the other hand, although MobileNetV2 (FIG. 4B) displayed a coherent t-SNE plot, this model had the poorest performance metrics for the fully fed class. Notably, the t-SNE plot for EfficientNet-B0 (FIG. 4C) demonstrated better alignment with its performance metrics for all classes. The markers corresponding to each color (representing a gonotrophic stage) were distinctly located in separate areas on the plot, reaffirming that the AI had effectively learned discernible features, and classified them accurately.

### Enhancing Model Explainability Utilizing Grad-CAMs

In this study, we provide further explainability of our AI model (EfficientNet-B0 only). In our study, we attempt to do so using the technique of Grad-CAM [11]. Grad-CAM is a technique that leverages the gradients of each target class as they propagate through the final convolutional layer of a neural network. By analyzing these gradients, Grad-CAM generates a coarse localization map that highlights the important regions of an image that contribute to the network's prediction for a specific class. To accomplish this, Grad-CAM first computes the gradients of the target class with respect to the feature maps produced by the final convolutional layer. These gradients serve as important weights, indicating how crucial each feature map is for predicting the class of interest. Next, the gradients are global-average-pooled to obtain a single weight per feature map. This pooling operation helps to capture the overall importance of each feature map rather than focusing on individual spatial locations. Finally, the weights are combined with the corresponding feature maps using a weighted combination, producing the final localization map. This map provides a visual representation of the regions in the image that are most relevant for the neural network's decision-making process regarding the target class. In the resulting implementation of this technique, the pixels in an image that were prioritized more during a classification will appear progressively redder, while those pixels prioritized less will appear progressively bluer.

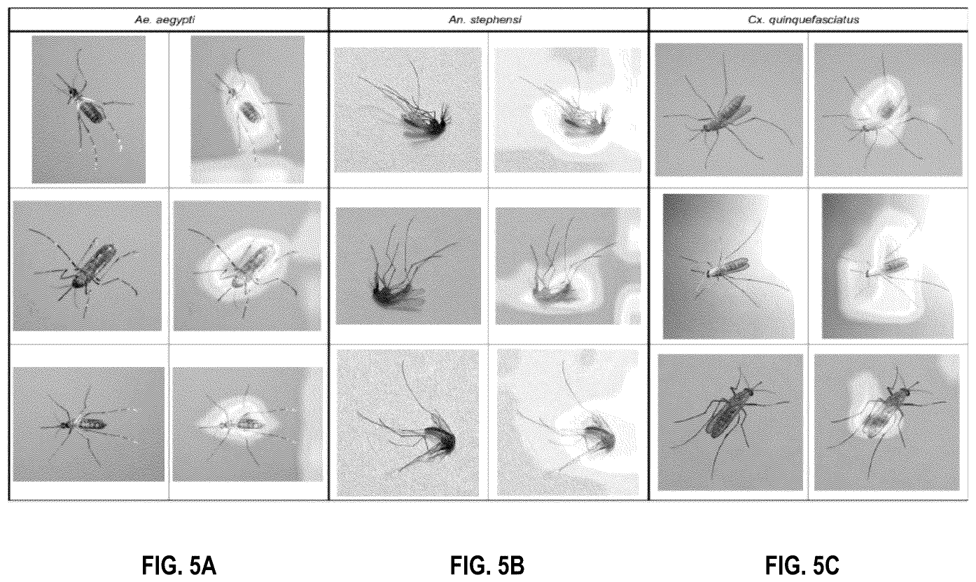

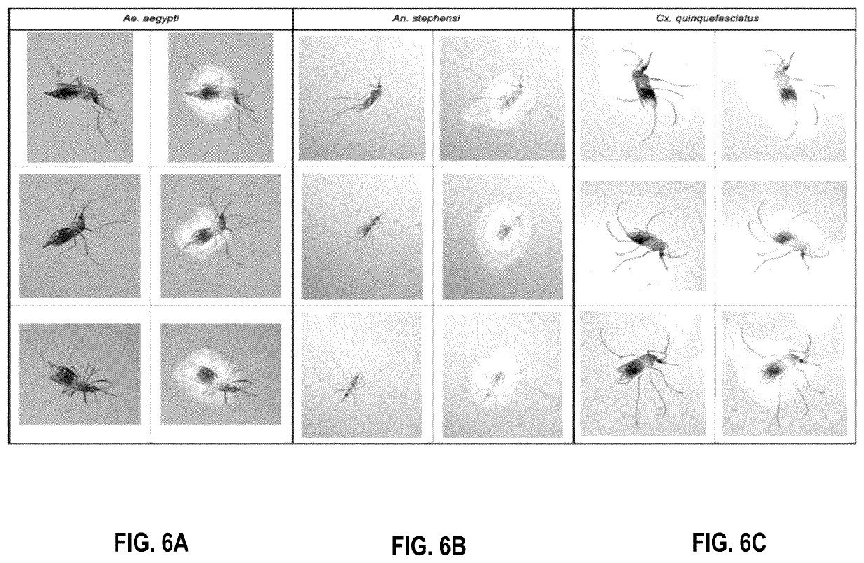

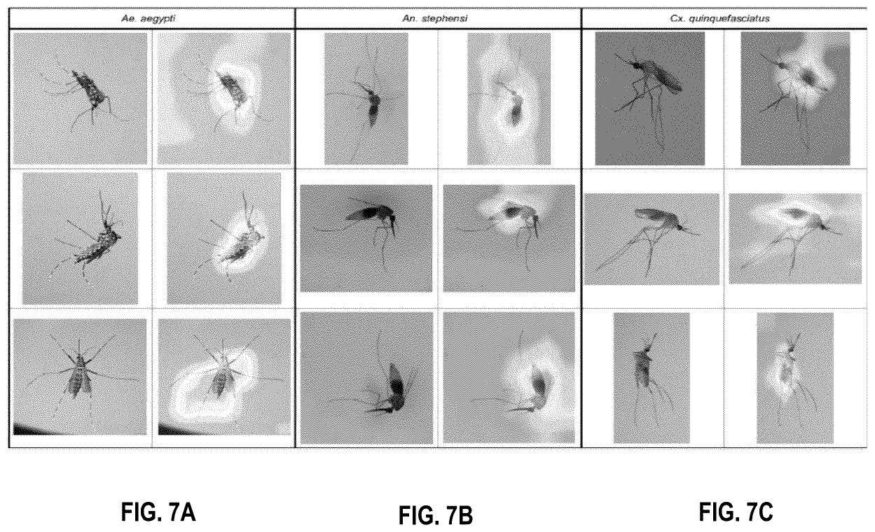

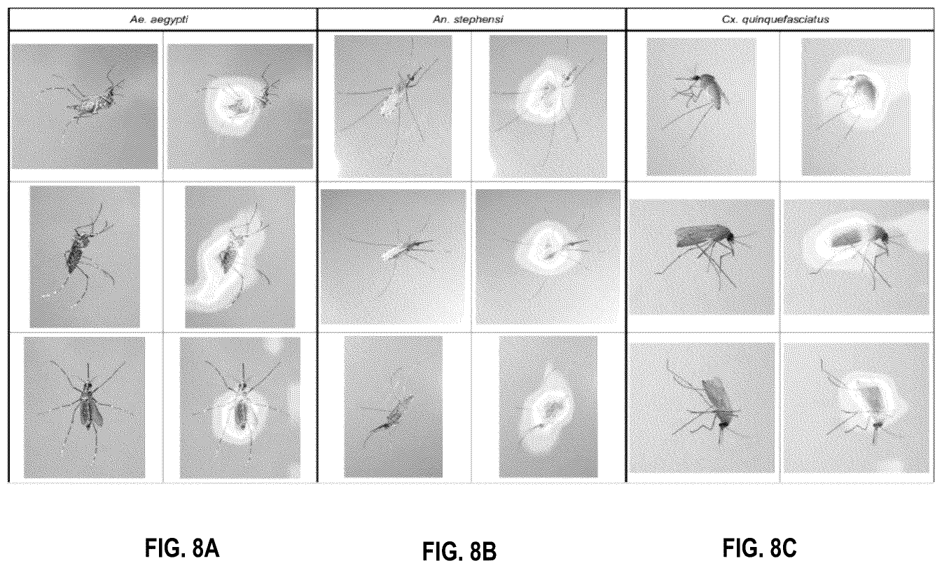

FIGS. 5A-5C, FIGS. 6A-6C, FIGS. 7A-7C, and FIGS. 8A-8C show specific instances of Grad-CAM outputs on test images based on classifications made by our EfficientNet-B0 model, organized by gonotrophic stage and species. Results demonstrated that the redder pixels are indeed concentrated in and around the abdomen in all instances. This provides a high degree of confidence that the EfficientNet-B0 model has learned correctly from the right anatomical components in an image, and we can hence explain the classification of gonotrophic stages in a mosquito. We mention here that while only some instances are presented in FIGS. 5A-5C, FIGS. 6A-6C, FIGS. 7A-7C, and FIGS. 8A-8C, the results are indeed generalizable.

### Discussion

The surveillance and control of mosquito vectors is a critical aspect of epidemiology, but the process is fraught with obstacles. The standard surveillance practice is to lay mosquito traps in an area of interest, after which the trapped mosquitoes—sometimes hundreds per trap—are brought to a lab and spread out on a board that is light-colored for visual inspection one-by-one (to identify to species, gonotrophic stage, etc.). Sometimes, a microscope is needed too. This process is arduous, manual, and time-consuming. Additionally, across the globe, entomology is a profession for which expertise is increasingly difficult to find and sustain. There is a clear need to automate the surveillance process, with practical ramifications elaborated below [13,14].

Knowing the abundance of mosquitoes in each gonotrophic stage is important for a variety of assessments, including near-time forecasting of the population of vector mosquitoes (via knowing the abundance of gravid mosquitoes), the effectiveness of eradication strategies in controlling vectors, conduciveness of local climactic factors for reproduction (gleaned via the ratio of the number of gravid to fully fed mosquitoes), and propensity for diseases to spread in any area during any outbreak (based on the number of blood-fed mosquitoes).

For the specific case of malaria (and also for other mosquito-borne diseases), it has been shown that understanding the gonotrophic stages of mosquitoes has vital importance for disease control and associated environmental impact [3,4]. Specifically, it has been shown that being aware of the timing of blood meals and egg laying will enable highly targeted eradication strategies to reduce mosquito populations and hence diseases. This is because a targeted plan to use pesticides across space and time will not only suppress mosquito populations and the spread of disease effectively, but it will also lower costs and the associated environmental impact.

Mosquito fecundity is primarily determined by their neurosecretory system, the amount of blood they consume, and local climatic circumstances [15,16]. If any of these conditions are unfavorable, fertility decreases. Hence, the effect of a single factor on fecundity can be determined, after controlling for other variables, by determining the relative abundance of mosquitoes in various gonotrophic stages. In addition, given species-specific and gonotrophic stage knowledge, public health experts can compare the fecundity of different mosquito species to gain a deeper understanding of the differences in their reproductive biology.

Knowledge of the gonotrophic stages is also critical to other facets of mosquito-borne disease epidemiology. For example, a fully fed mosquitoes are required for enzyme-linked immunosorbent assays (ELISA), to identify human blood meals in mosquitoes [17], and semi-gravid mosquitoes are required for cytogenetic analysis to assess chromosomal mutations [18].

Furthermore, since a mosquito needs to have consumed a blood meal to carry pathogens, an automated and rapid mechanism to classify a fed mosquito from an unfed one will enhance operational efficiency in determining the presence or absence of pathogens in any specific mosquito during outbreaks.

Beyond merely helping entomologists save time in gonotrophic stage identification, the impact of our paper extends onto two novel avenues. The first is leveraging image data generated by citizen science (aka. Community science). Our team is now close partners with three well-established platforms that the general public uses to upload mosquito observations. These platforms are Mosquito Alert [19], iNaturalist [20], and GLOBE Observer's Mosquito Habitat Mapper [21]. Via these partnerships, we work with volunteers across Africa, the Americas, and Europe to train citizen scientists on best practices for recording and uploading mosquito observations from smartphones. Furthermore, utilizing Open Geospatial Consortium standards, we have harmonized data streams from all of these platforms to facilitate interoperability and utility for experts and the general public. This GIS mapping platform, the Global Mosquito Observations Dashboard (GMOD), is accessible at www.mosquitodashboard.org for visualizing and downloading data in multiple tabular and geospatial formats (>300K observations to date) [22, 23]. We are currently integrating computer vision algorithms that we have designed and validated in prior work [22-25] to process images from these citizen science platforms for species identification (and soon for gonotrophic stage identification). Notably, most mosquito images uploaded by citizen scientists are taken indoors with a light-colored wall background when the mosquito is resting. This is also a reason why the images of mosquitoes in our dataset were taken on a gray- or white-colored background.

The second novel practical impact of our work lies in augmenting AI technologies that we and multiple other groups are designing to identify mosquito species automatically, thereby eliminating the need for expert human involvement [26-28]. While in some technologies, a mosquito must be emplaced in an imaging system [26], in other technologies, mosquito images are captured in flight inside the trapping chamber [29]. In either case though, the background is light-colored to provide appropriate contrast. Ultimately, the algorithms shared in our paper (Data availability) can enable novel tools that harness the power of both AI and the general public, as they upload images from which we can now not only identify vector mosquitoes but also their gonotrophic stages, with greater utility for mosquito surveillance and control.

### CONCLUSIONS

In this study, we developed computer vision approaches to automate the determination of gonotrophic stages from mosquito images. Our data came from mosquitoes distributed across three important species: Ae. aegypti, An. stephensi, and Cx. quinquefasciatus. A total of 139 mosquitoes were raised in two separate facilities, and they went through the four gonotrophic stages: unfed, fully fed, semi-gravid, and gravid. Using multiple smartphones, 1959 photographs of these mosquitoes were captured against a plain background. Following that, we trained and tested four diverse but popularly used AI model architectures and implemented explainable AI techniques (t-SNE, Grad-CAMs) to validate their outcomes. Overall, the EfficientNet-B0 model gave the best performance when combining model accuracy, model size, distinguishable t-SNE plots, and correct Grad-CAMs.

To the best of our knowledge, our contributions in this paper are the first towards automating the process of determining the gonotrophic stage of a mosquito using computer vision techniques. We believe that our method provides novel tools for entomologists, citizen-science platforms, and image-based mosquito surveillance. With the increasing spread and resurgence of mosquito-borne diseases across the globe (e.g., the first local transmission of malaria in the US in two decades this summer), our study assumes critical and urgent significance.

Methods: Generation of image database and augmentation. The images comprising our dataset came from mosquitoes raised in captivity in two separate labs. One lab is in South India, and the other is in the US. The mosquitoes raised in South India belonged to three species: Ae. aegypti, An. stephensi, and Cx. quinquefasciatus. Mosquitoes were fed with chicken and sheep blood in India and the US respectively. It took about two minutes for the mosquitoes to reach a fully fed state. After this, the mosquitoes took about 24 hours to move from one stage in the gonotrophic cycle to the next. At each stage, the mosquitoes were visually observed by entomological experts to determine the correct stage. Please note that after visual identification, live mosquitoes were emplaced in test tubes and anesthetized using a few drops of diethyl ether added to the cotton plug of the test tubes. Within a minute, mosquitoes were anesthetized. The mosquitoes were then photographed over a plain grey or white background with multiple smartphones. The background was chosen specifically since (a) entomologists today emplace mosquitoes on a light-colored platform for identification; (b) citizen-uploaded images of mosquitoes in portals today are predominantly taken indoors on a light-colored background; and (c) the light-colored background provides the highest contrast. The reason for taking images via multiple smartphones was to introduce noise that commonly occurs in real life due to diversity across cameras, and is a standard procedure in computer vision. This same image-capturing procedure was also followed for the mosquitoes raised in the US, except that these were only An. stephensi mosquitoes, and the photographs taken were for the unfed and semi-gravid stages only. The final dataset contained 579 images of unfed female mosquitoes, 521 images of fully fed mosquitoes, 438 images of semi-gravid mosquitoes, and 421 images of gravid mosquitoes across the three species (see Table 1). It is important to note here that a mosquito that was photographed in one stage was not used for photographs taken in another stage. In other words, photographs of a single mosquito specimen were taken for only one gonotrophic stage in our dataset. This alleviates pseudo-replication concerns in our dataset.

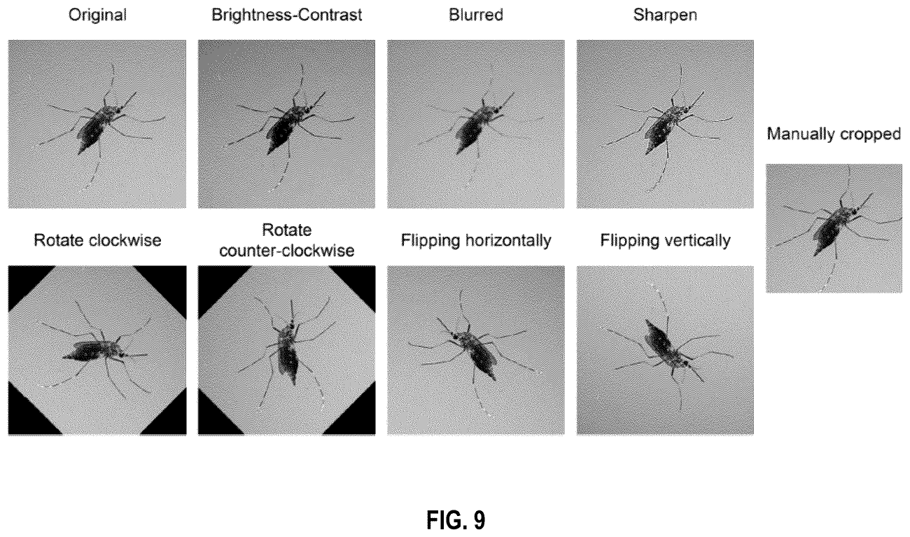

Once the images were generated, the entire image and species dataset was split into training, validation, and testing sets in the proportion of 80% (1504 images), 10% (221 images), and 10% (234 images), respectively. Images in the training set were augmented, which is a standard step before developing AI models. The idea here is to introduce sufficient diversity to the training samples, so that the model learns to better ignore noninformative variation during practical use, and is not over-fitted. To augment the training images (i.e., add diversity to the 1504 training images), we used eight methods that are standard in image processing—rotating clockwise (a) and counter-clockwise (b), flipping horizontally (c) and vertically (d), changing blurriness (c) and sharpness (f), altering brightness randomly from 5 to 20% (g), and manually cropping images to extract only the mosquito body (h). FIG. 9 shows eight augmented images with the original image of a sample mosquito. After augmentation, the number of training samples per class was increased by a factor of eight. The images in the validation and testing sets were not augmented.

### Our Deep Neural Network Architectures to Classify Gonotrophic Stages of Mosquitoes: Deep Neural Networks Architectures Rationale

In this paper, we trained and validated four distinct deep neural network architectures for gonotrophic stage classification—ResNet50, MobileNetV2, EfficientNet-B0, and ConvNeXtTiny. All these architectures are popular in the literature and are sufficiently diverse. The ResNet50 [5] architecture employs a series of residual blocks, each containing convolutional layers and utilizing a bottleneck design to optimize computation. ResNet50 [5] addresses the vanishing gradient problem by introducing shortcut connections (skip connections) which help in training very deep neural networks. However, this model can be computationally very intensive and memory-consuming due to the increased depth and the necessity to store intermediate activations for the skip connections. This can make it challenging to deploy on resource-constrained devices or platforms. A lighter-sized model well-suited for execution on embedded devices like smartphones is MobileNetV2 [6], which utilizes depth-wise separable convolutions, significantly reducing the number of parameters and computations compared to traditional convolutional layers. This makes it highly efficient for mobile and embedded devices, allowing for faster inference and lower memory requirements. The efficiency gain achieved in MobileNetV2 comes at the cost of some loss in accuracy compared to larger and more computationally intensive models. As a trade-off between accuracy and computation cost, we chose the EfficientNet-B0 [7] model for training and validation. It has achieved state-of-the art performance across various tasks while requiring fewer parameters compared to other architectures. Instead of independently scaling the width, depth, and resolution of the network, EfficientNet-B0 scales all three aspects simultaneously and uniformly using scaling coefficients. Thus it strikes a superior balance between model size, computational efficiency, and accuracy, making it highly efficient for practical applications and deployment. Apart from these three convolutional neural networks, we finally trained and validated ConvNeXtTiny [8], a recent neural network inspired by the concepts of Vision Transformers [9] (which are very state-of-the-art now, but heavy). It employs a technique known as depth-wise convolution and it is a distinct approach to image processing where the network analyzes various segments of the image independently. This method effectively cuts down on the required computational workload while preserving accuracy.

Optimization of hyperparameters. As is customary in developing deep neural network architecture, hyperparameters are determined by multiple rounds of training and validation on the dataset [30]. Critical hyperparameters tuned in our neural network architecture are presented in Table 6. Please note that Table 6 lists those hyperparameters that we used for training and validating the EfficientNet-B0 model although they were very similar for the other three architectures too.

Resized images: To maintain image consistency, we must resize them. As images were collected data from numerous cell phones for our problem, we downsized each input image to 224×224×3 pixels, regardless of its actual dimension for consistency. This enables us to achieve faster training without loss of image quality. We standardized the RGB value of each pixel in the image by dividing it by 255.

Optimizer: In this work, the Adam (Adaptive Moment Estimation) optimization algorithm was utilized. This technique enables adaptive learning rates for weights across architectural layers, so that lower rates are allocated to weights receiving larger updates and higher rates are given to weights receiving smaller updates. The exponential decay rates for the first and second moment estimations (1 and 2) are set to 0.89 and 0.999 respectively.

Loss functions: In this study, we utilized the categorical cross-entropy loss function. This function minimizes the difference between the expected probability function and the actual probability function. This is in contrast to other loss functions, such as focal loss and triplet loss, which perform better when variations in terms of the complexity of entities inside classes and their inter-variabilities are greater, neither of which is true for our situation.

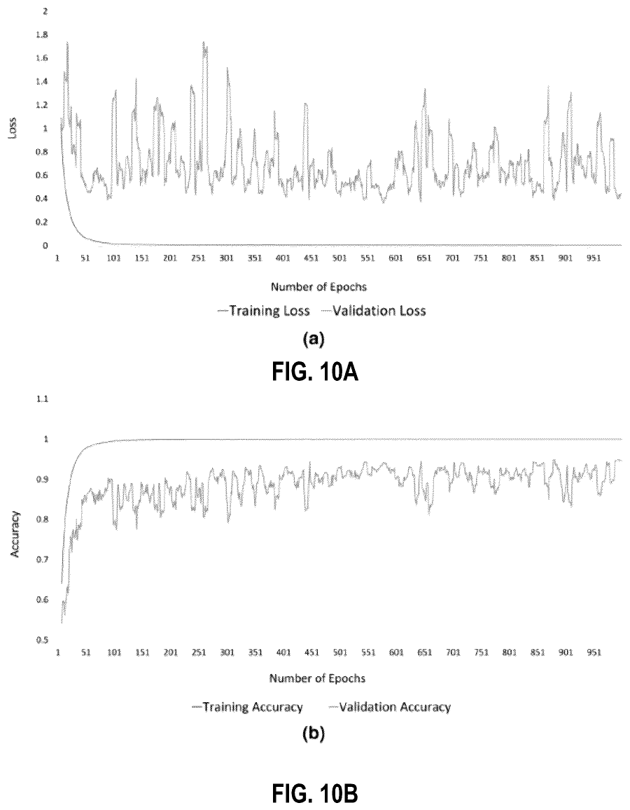

Fine-tuning of the architecture and compensating for overfitting: For fine-tuning, we initially froze the layers of the base model (all the layers except for the dense layers we appended to the bottom of the architecture (see Table 5)) with the weights of a pre-trained model that was trained on the ImageNet of 14 million images of 20,000 categories. Since the model was already trained on a large dataset, these weights were already highly optimized. That is why we only trained the last 14 layers of the model with a higher learning rate (1e−3). After training with 500 epochs, we unfroze all layers and again trained the model with a smaller learning rate (1e−5) so that the change in weights would be smaller. Within 500 epochs (in total 1000), the model reached the best optimization. FIG. 10 and FIG. 10B are graphs showing the loss and accuracy for each iteration during training and validation of the EfficientNet-B0 model. We have used Python DL libraries (keras33, tensorflow34) to implement the codes and trained on an Intel Xeon E5-2620 v4 processor with 128 GB GPU memory.

TABLE 5
EfficientNet-B0 model architecture with layer
information (input and output sizes).

| Layer | Size in | Size out |
|---|---|---|
| Top_activation (layer 236 | (None, 7, 7, 1280) | (None, 7, |
| in EfficientNet-B0) | | 7, 1280) |
| Average_pooling2d | (None, 7, 7, 1280) | (None, 1, |
| | | 1, 1280) |
| Dense_1 | (None, 1, 1, 1280) | 256 |
| Dense_2 | 256 | 128 |
| Dense_3 | 128 | 128 |
| Concatenate | (Dense_1, | 512 |
| | Dense_2, | |
| | Dense_3) | |
| Softmax | 512 | 4 |

TABLE 6
Values of critical hyperparameters in
training the EfficientNet-B0 model.

| Hyperparameter | Value |
|---|---|
| Number of layers | 250 |
| Learning rate | 1e−3 for 1-500 epochs |
| | 1e−5 for 501-1000 epochs |
| Optimizer | Adam |
| Batch size | 16 |
| Loss function | Categorical cross-entropy |
| Number of epochs | 1000 |

### Related Work

Mosquito surveillance and control are critical tasks in epidemiology. There is always a need to enhance the speed and scale of these activities, especially with rising cases of mosquito-borne diseases across the globe. In the past decade or so, citizen-science platforms such as iNaturalist [20], Mosquito Alert [19], and Mosquito Habitat Mapper have been deployed with great success [22, 35], enabling non-experts to take and upload photographs of mosquitoes that they encounter in nature. Experts can then identify and analyze these data, hence providing a new source of surveillance information beyond the limits of traditional trapping methods. In addition, rapid advancements in AI techniques have also enabled numerous image processing methods for mosquito identification. Specific problems addressed by such studies are presented below in limited detail.

Goodwin et al. [26] presented a method for identifying mosquito species using convolutional neural networks (CNNs) and a multitiered ensemble model. The approach utilized deep learning techniques to analyze mosquito images and accurately classify 67 mosquito species. Kittichai et al., [36] focused on utilizing the well-known deep learning techniques: you-only-look-once (YOLO) algorithm [37] for the identification of both mosquito species and gender. The YOLO algorithm, with its ability to handle complex and challenging visual data, aided in accurately identifying and classifying mosquito vectors. Kittichai proposed to concatenate two YOLO v3 [38] models and was able to show optimal performance in mosquito species and gender classification. Finally, our prior work has demonstrated the utility of CAMs in the identification of mosquito species [22,24]. To the best of our knowledge, there is no work yet in the literature on automating the determination of gonotrophic stages in a mosquito, hence making the contributions in this paper unique and practically impactful.

### Configuration of Certain Implementations

The construction and arrangement of the systems and methods as shown in the various implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions, and arrangement of the implementations without departing from the scope of the present disclosure.

The present disclosure contemplates methods, systems, and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor.

When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

It is to be understood that the methods and systems are not limited to specific synthetic methods, specific components, or to particular compositions. It is also to be understood that the terminology used herein is for the purpose of describing particular implementations only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another implementation includes from the one particular value and/or to the other particular value. Similarly, when values are expressed as approximations, by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal implementation. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific implementation or combination of implementations of the disclosed methods.

The following patents, applications and publications as listed below and throughout this document are hereby incorporated by reference in their entirety herein.
[1] Yee, D. A. et al. Robust network stability of mosquitoes and human pathogens of medical importance. Parasites & Vectors 15, 216 (2022).
[2] Malaria, unicef: Status update on children. 25 Apr. 2020. https://data.unicef.org/resources/malaria-snapshots-sub-saharan-africa-and-impact-of-covid19 (2020).
[3] Ferguson, H. M. et al. Ecology: A prerequisite for malaria elimination and eradication. PLOS Med. 7, e1000303 (2010).
[4] Williams, J. & Pinto, J. Training manual on malaria entomology for entomology and vector control technicians (basic level). USAID. Washington, DC78 (2012).
[5] He, K., Zhang, X., Ren, S. & Sun, J. Deep residual learning for image recognition. In Proceedings of the IEEE Conference on Computer Vision and Pattern Recognition, 770-778 (2016).
[6] Sandler, M., Howard, A., Zhu, M., Zhmoginov, A. & Chen, L.-C. Mobilenetv2: Inverted residuals and linear bottlenecks. In Proceedings of the IEEE Conference on Computer Vision and Pattern Recognition, 4510-4520 (2018).
[7] Tan, M. & Le, Q. Efficientnet: Rethinking model scaling for convolutional neural networks. In International Conference on Machine Learning, 6105-6114 (PMLR, 2019).
[8] Liu, Z. et al. A convnet for the 2020s. In Proceedings of the IEEE/CVF Conference on Computer Vision and Pattern Recognition, 11976-11986 (2022).
[9] Dosovitskiy, A. et al. An image is worth 16×16 words: Transformers for image recognition at scale. arXiv preprint arXiv: 2010. 11929 (2020).
[10] Van der Maaten, L. & Hinton, G. Visualizing data using t-sne. J. Mach. Learn. Res. 9 (2008).
[11] Selvaraju, R. R. et al. Grad-cam: Visual explanations from deep networks via gradient-based localization. In Proceedings of the IEEE International Conference on Computer Vision, 618-626 (2017).
[12] Kullback, S. & Leibler, R. A. On information and sufficiency. Ann. Math. Stat. 22, 79-86 (1951).
[13] Yamany, A. S. Studies on the development of the ovaries of the malaria mosquitoes (anopheles pharoensis). J. Vaccines Vaccin. 3, 1-6 (2012).
[14] Martínez-de la Puente, J., Ruiz, S., Soriguer, R. & Figuerola, J. Effect of blood meal digestion and DNA extraction protocol on the success of blood meal source determination in the malaria vector anopheles atroparvus. Malar. J. 12, 1-6 (2013).
[15] Detinova, T. S., Bertram, D. S., Organization, W. H. et al. Age-Grouping Methods in Diptera of Medical Importance, with Special Reference to Some Vectors of Malaria (World Health Organization, 1962).
[16]. Christophers, S. The development of the egg follicles in anophelines. Paludism 2, 73-88 (1911).
[17] Edrissian, G. H., Manouchehry, A. & Hafizi, A. Application of an enzyme-linked immunosorbent assay (elisa) for determination of the human blood index in anopheline mosquitoes collected in iran. J. Am. Mosq. Control Assoc. 1, 349-352 (1985).
[18] Bellini, R. et al. Use of the sterile insect technique against Aedes albopictus in Italy: First results of a pilot trial. In Area-Wide Control of Insect Pests: From Research to Field Implementation, 505-515 (Springer, 2007).
[19] Citizen science to investigate and control disease-carrying mosquitoes. http://www.mosquitoalert.com/en/. Accessed: 2023 May 22.
[20] A community for naturalists⋅inaturalist. https://www.inaturalist.org/. Accessed: 2023 May 22.
[21] The globe observer mosquito habitat mapper. https://observer.globe.gov/toolkit/mosquito-habitat-mapper-toolkit. Accessed: 2023 May 22.
[22] Carney, R. M. et al. Integrating global citizen science platforms to enable next-generation surveillance of invasive and vector mosquitoes. Insects 13, 675 (2022).
[23] Uelmen Jr, J. A., et al. Global mosquito observations dashboard (GMOD): Creating a user-friendly web interface fueled by citizen science to monitor invasive and vector mosquitoes. Int. J. Health Geogr. 22, 28 (2023).
[24] Minakshi, M. et al. Automating the surveillance of mosquito vectors from trapped specimens using computer vision techniques. In Proceedings of the 3rd ACM SIGCAS Conference on Computing and Sustainable Societies, 105-115 (2020).
[25] Minakshi, M., Bharti, P., Bhuiyan, T., Kariev, S. & Chellappan, S. A framework based on deep neural networks to extract anatomy of mosquitoes from images. Sci. Rep. 10, 1-10 (2020).
[26] Goodwin, A. et al. Mosquito species identification using convolutional neural networks with a multitiered ensemble model for novel species detection. Sci. Rep. 11, 13656 (2021).
[27] Goodwin, A. et al. Development of a low-cost imaging system for remote mosquito surveillance. Biomed. Opt. Express 11, 2560-2569 (2020).
[28] Chellappan, S., Minakshi, M., Bharti, P. & Carney, R. M. Systems and methods for classifying mosquitoes based on extracted masks of anatomical components from images (2023). U.S. patent application Ser. No. 17/462,809.
[29] Chellappan, S., Saddow, S. E., Carney, R. M., Wolfram, B. & Weston, M. Smart mosquito trap for mosquito classification (2022). U.S. patent application Ser. No. 17/496,563.
[30] Brownlee, J. How to grid search hyperparameters for deep learning models in python with keras. línea]. Disponible en: https://machinelearningmastery.com/grid-search-hyperparameters-deep-learning-models-python-keras (2016).
[31] Zhang, Z. Improved adam optimizer for deep neural networks. In 2018 IEEE/ACM 26th International Symposium on Quality of Service (IWQoS), 1-2, https://doi.org/10.1109/IWQoS. 2018. 86241 83 (2018).
[32] Deng, J. et al. Imagenet: A large-scale hierarchical image database. In 2009 IEEE Conference on Computer Vision and Pattern Recognition, 248-255 (IEEE, 2009).
[33] Chollet, F. et al. Keras. https://keras.io (2015).
[34] The TensorFlow Authors. Tensorflow: Large-scale machine learning on heterogeneous systems. https://www.tensorflow.org/(2015).
[35] Sousa, L. B. et al. Methodological diversity in citizen science mosquito surveillance: a scoping review. Citizen Science: Theory and Practice 7 (2022).
[36] Kittichai, V. et al. Deep learning approaches for challenging species and gender identification of mosquito vectors. Sci. Rep. 11, 4838 (2021).
[37] Redmon, J., Divvala, S., Girshick, R. & Farhadi, A. You only look once: Unified, real-time object detection. In Proceedings of the IEEE Conference on Computer Vision and Pattern Recognition, 779-788 (2016).
[38] Redmon, J. & Farhadi, A. Yolov3: An incremental improvement. arXiv preprint arXiv: 1804. 02767 (2018).

What is claimed is:

1. A computer-implemented method comprising:
receiving, by at least one processor, an image data set, wherein the image data set comprises a plurality of images that each depict a respective mosquito of a plurality of mosquitoes at a location;
processing, by the at least one processor, at least a portion of the image data set using an image segmentation operation to determine a current gonotrophic phase for each of at least a portion of the plurality of mosquitoes;
determining, by the at least one processor using a trained machine learning model and based at least in part on the determined current gonotrophic phases, a predictive output indicative of an expected population of mosquitoes at the location during a future time period; and
outputting, by the at least one processor, an indication of the expected population of mosquitoes.

2. The computer-implemented method of claim 1, further comprising:
triggering, by the at least one processor, an alert and/or corrective operation in an instance in which the expected population meets or exceeds a predetermined threshold value.

3. The computer-implemented method of claim 2, wherein the corrective operation comprises generating and/or outputting an indication of a mosquito population control plan.

4. The computer-implemented method of claim 1, wherein each current gonotrophic phase is unfed, fully fed, semi-gravid, or gravid state.

5. The computer-implemented method of claim 1, wherein processing at least a portion of the image data set comprises identifying female mosquitoes in at least a portion of the image data set.

6. The computer-implemented method of claim 1, wherein the expected population of mosquitoes is determined based at least in part on a ratio of gravid to fully fed mosquitoes at the location.

7. The computer-implemented method of claim 1, wherein the image data set is captured via at least one image sensor of at least one mobile device.

8. The computer-implemented method of claim 1, further comprising:
performing, by the at least one processor, a dimensionality reduction operation on at least a portion of the image data set.

9. The computer-implemented method of claim 1, wherein processing at least a portion of the image data set comprises performing a depth-wise convolution operation.

10. The computer-implemented method of claim 1, wherein the machine learning model comprises at least one of a deep learning model, a neural network model, a transformer-based model, or a convolutional neural network model (e.g., EfficientNet-b0).

11. A system comprising:
at least one processor (e.g., cloud-based processing system); and
a memory having instructions thereon, wherein the instructions when executed by the at least one processor, cause the at least one processor to:
receive an image data set, wherein the image data set comprises a plurality of images that each depict a respective mosquito of a plurality of mosquitoes at a location;
process at least a portion of the image data set using an image segmentation operation to determine a current gonotrophic phase for each of at least a portion of the plurality of mosquitoes;
determine, using a trained machine learning model and based at least in part on the determined current gonotrophic phases, a predictive output indicative of an expected population of mosquitoes at the location during a future time period; and
output an indication of the expected population of mosquitoes.

12. A method comprising:
feeding a subset of a plurality of mosquitoes at a location to reach a gravid state;
generating a first training image data set from a plurality of images, wherein each image depicts at least one of the plurality of mosquitoes;
augmenting the first training image set using at least one image augmentation operation to generate a second training image data set;
training a machine learning model using the second training image data set; and
validating performance of the trained machine learning model using the first training image data set.

13. The method of claim 12, wherein each image is obtained via a different image sensor and/or mobile device and/or from multiple angles.

14. The method of claim 12, wherein the at least one image augmentation operation comprises at least one of: rotating clockwise and counter-clockwise, flipping horizontally and vertically, changing blurriness and sharpness, altering brightness randomly from 5% to 20%, or manually cropping images to extract only a mosquito body.

15. The method of claim 12, wherein training the machine learning model comprises a first training stage performed at a higher learning rate and a second training stage performed at a smaller learning rate.

16. The method of claim 12, wherein pixels corresponding with a mosquito abdomen in each image are weighted higher than pixels corresponding to other body parts.

17. The method of claim 12, further comprising:
determining an efficiency of the trained machine learning model; and
outputting a visualization corresponding to the determined efficiency.

18. The method of claim 17, wherein the visualization comprises a localization map showing pixels in each image that were prioritized for classification of each mosquito.

19. The method of claim 12, further comprising:
analyzing gradients of at least one target class as it propagates through the machine learning model; and
generating a localization map based on the analyzed gradients.

20. The method of claim 12, wherein the machine learning model comprises at least one of a deep learning model, a neural network model, a transformer-based model, or a convolutional neural network model (e.g., EfficientNet-b0).
